(19) United States
(12) Patent Application Publication
(10) Pub. No.: US 2013/0277285 A1
(43) Pub. Date: Oct. 24, 2013

(54) MULTI-CANISTER WATER-FILTRATION SYSTEM

(71) Applicant: AQUA IP, Auburn, WA (US)

(72) Inventors: Scott Borough, Renton, WA (US); Larry Meek, Renton, WA (US); Laren Meek, Renton, WA (US)

(73) Assignee: AQUA IP, Auburn, WA (US)

(21) Appl. No.: 13/868,788

(22) Filed: Apr. 23, 2013

Related U.S. Application Data
(60) Provisional application No. 61/636,990, filed on Apr. 23, 2012.

(51) Int. Cl. B01D 35/143

(52) U.S. Cl. CPC B01D 35/143
USPC 210/90

(57) ABSTRACT

The current application is to multi-canister water-filtration systems with two or more canister-type water filters as well as pressure-monitoring components to allow for the pressure drop across at least one of the canister-type water filters to be monitored and filtration-efficiency degradation detected.

### CROSS-REFERENCE TO RELATED APPLICATION

This application claims the benefit of Provisional Application No. 61/637,006, filed Apr. 23, 2012.

### TECHNICAL FIELD

The current application is directed to water-filtration systems and, in particular, to a multi-canister water-filtration system that includes multiple canister-type water filters and filter-monitoring devices.

### BACKGROUND

Canister-type water filters have been available for many years for initial treatment of public-utility-supplied water and treatment of private-well water supplied to residential and commercial buildings. While cost effective and generally robust, canister-type water-filtration systems currently include only a single type of filter media and therefore exhibit relatively low efficiencies for removing certain classes of water contaminants while having relatively greater efficiencies for removing other classes of water contaminants. Furthermore, canister-type water filtration systems may exhibit significant pressure losses and various types of degradation over time, both of which are difficult to monitor for and detect. Building owners and residents continue to seek broader-spectrum and higher-capacity water-filtration systems which exhibit less and more easily detected filtration-efficiency degradation.

### SUMMARY

The current application is to multi-canister water-filtration systems with two or more canister-type water filters as well as pressure-monitoring components to allow for the pressure drop across at least one of the canister-type water filters to be monitored and filtration-efficiency degradation detected.

### BRIEF DESCRIPTION OF THE DRAWINGS

FIG. 1 shows an external view of a dual-canister multi-filter water-filtration system that represents one example of the water-filtration systems to which the current application is directed.

FIG. 2 shows the dual-canister multi-filter water-filtration system from the rear.

FIG. 3 shows a view of the dual-canister multi-filter water-filtration system from below.

FIG. 4 is an exploded view of the dual-canister multi-filter water-filtration system discussed above with reference to FIGS. 10-3.

### DETAILED DESCRIPTION

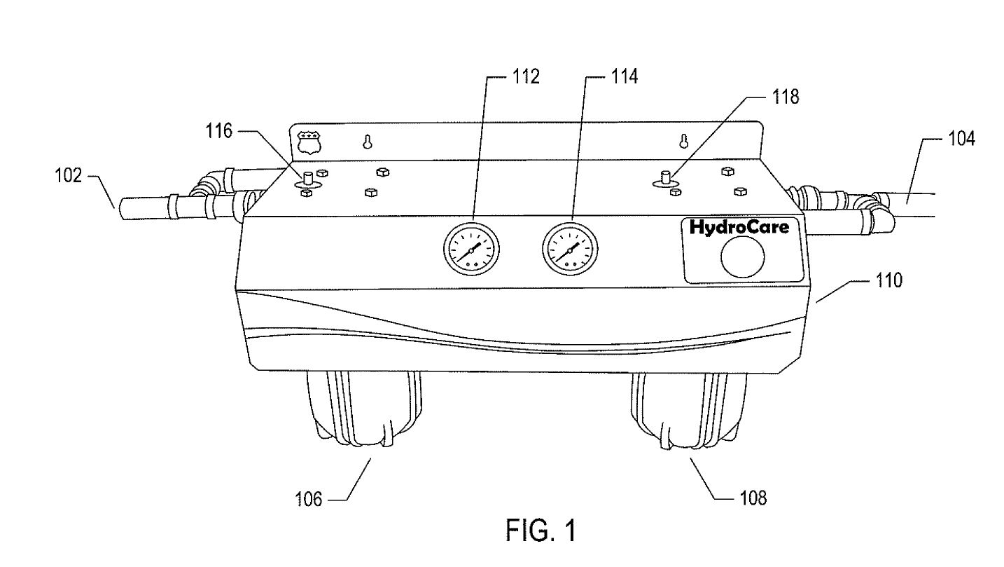

FIG. 1 shows an external view of a dual-canister multi-filter water-filtration system that represents one example of the multi-canister water-filtration systems to which the current application is directed. The dual-canister multi-filter water-filtration system receives input, untreated water in a source-water tube 102 and outputs filtered water to an output pipe 104. The filtration system includes two canister-type water filters 106 and 108 mounted below a shelf-like metal housing 110 with two pressure indicators 112 and 114. Pressure-relief buttons for the two canister-type filters are exposed through the housing 116 and 118.

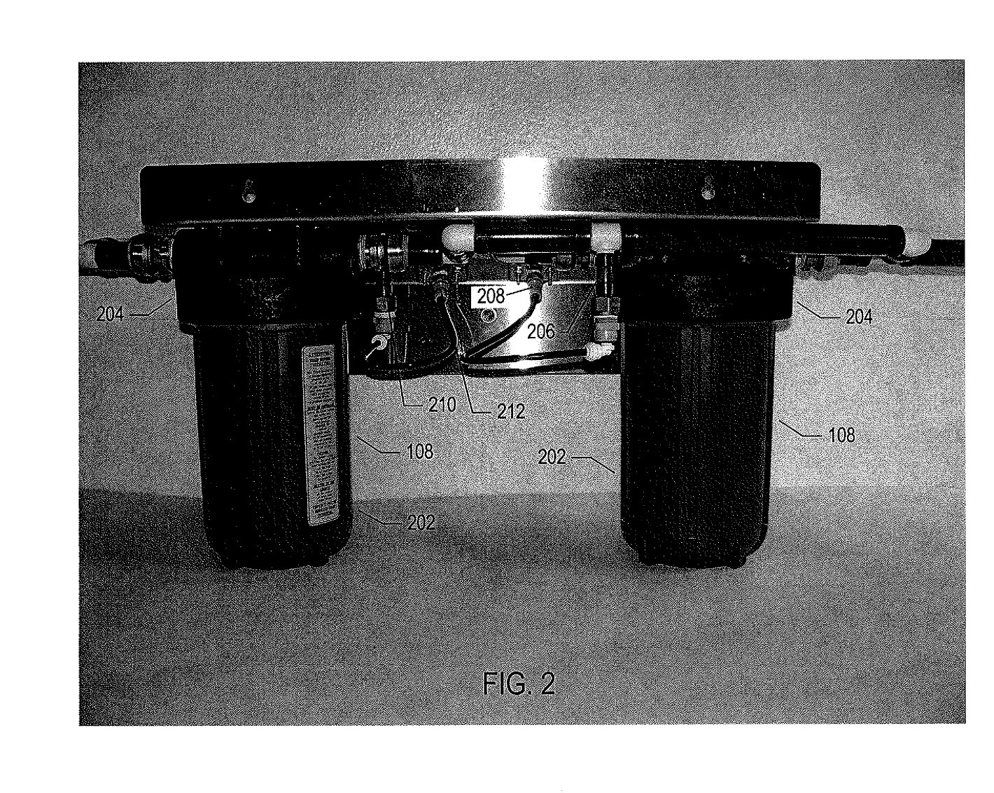

FIG. 2 shows the dual-canister multi-filter water-filtration system from the rear. In this illustration, the two canisters 106 and 108 are clearly visible, including the lower canister housings 202 and upper head units 204 for the canister-type water filters. A first tap 206 into the source-water pipe provides a source-water pipe pressure input 208 to the first pressure gauge (112 in FIG. 1) and a second pressure tap 210 in the output filter-water pipe provides a pressure input 212 to the second pressure gauge (114 in FIG. 1).

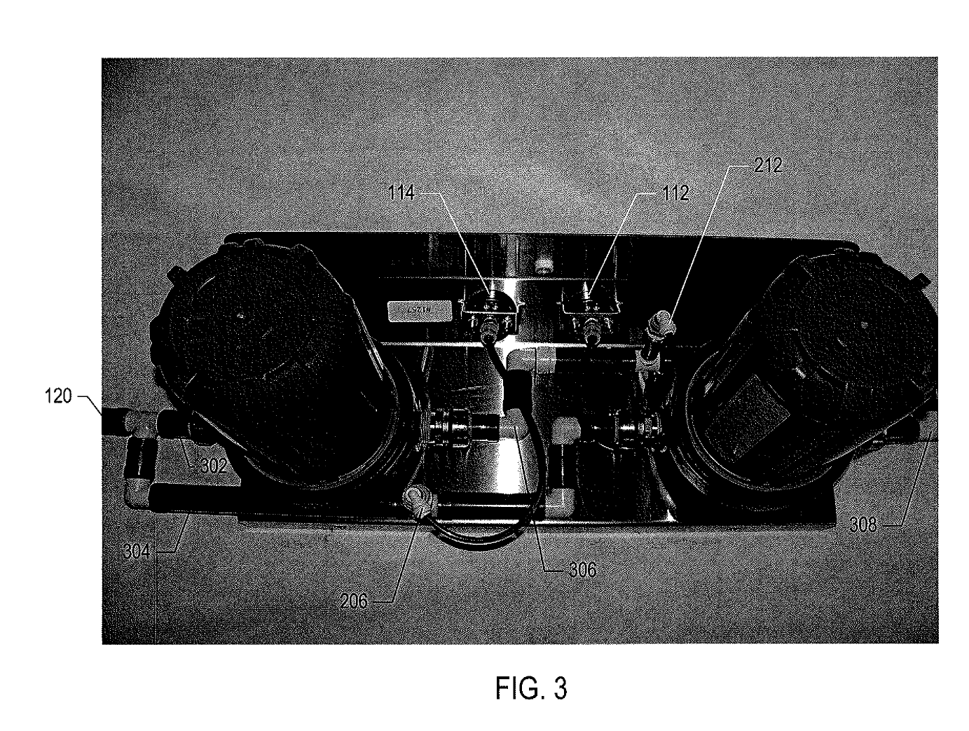

FIG. 3 shows a view of the dual-canister multi-filter water-filtration system from below. In this illustration, the second pressure gauge (114 in FIG. 1) and the first pressure gauge (112 in FIG. 1) are clearly visible, as are the taps 212 and 206 into the filtered-water pipe and source-water pipe, respectively. Note that the source-water pipe 102 branches into two source-water branches 302 and 304 input to the two canister-type filters and each canister-type filter separately outputs filtered water to output-branch pipes 306 and 308 that are later combined to form a single output pipe 104, as shown in FIG. 1.

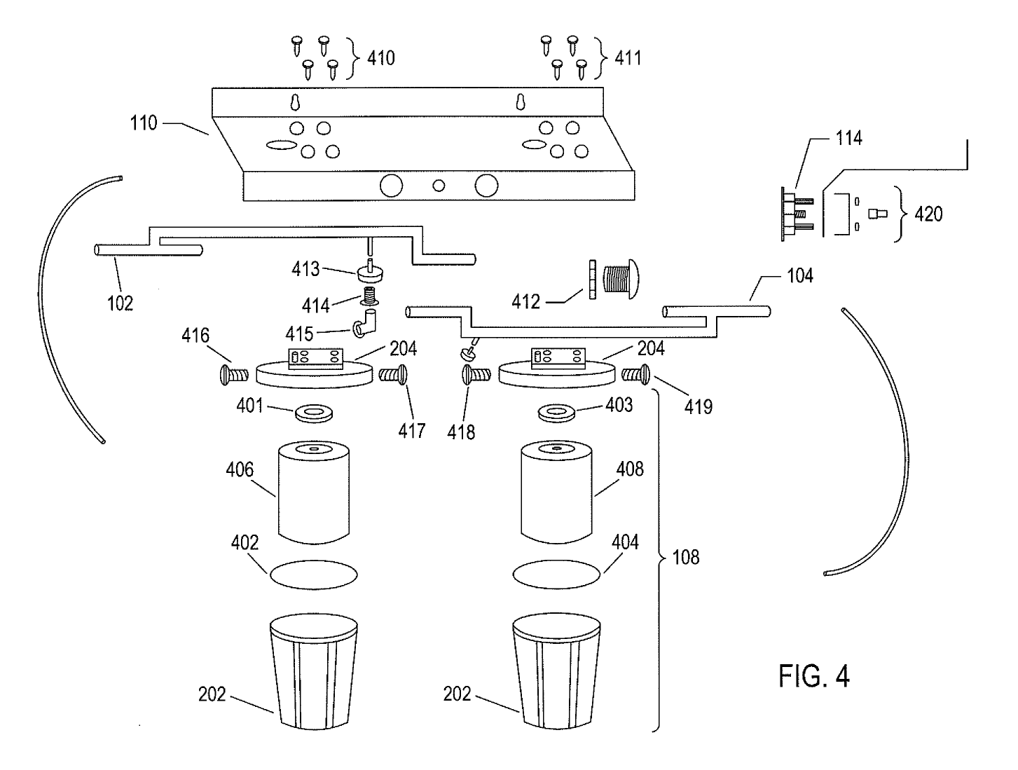

FIG. 4 is an exploded view of the dual-canister multi-filter water-filtration system discussed above with reference to FIGS. 1-3. For sake of conciseness, those elements already discussed and labeled with numeric labels in the previous figures are provided similar labels in FIG. 4. Note that the canister-type water filters each include multiple O-rings 401-404 and internal filter canisters 406 and 408. Additional fittings and fasteners are shown in FIG. 4.

By dividing the input water-source pipe into two branches, the input water is filtered, in parallel, by two canister-type water filters, decreasing by half the flow of water through each canister with respect to a single canister-type water filter effectively doubling the water-filter volume across which pressure is dropped. As a result, the lifetime of the water filters is extended and potential for significant pressure loss through the water-filtration system significantly decreased. The pressure gauges allow for this pressure drop across the first canister-type water filter to be monitored, so that critical contaminant loading and other conditions that may affect water-filtration efficiency can be prevented. Canister-type water filters are provided a stable, robust mounting platform that allows the canister housings to be unscrewed from the filter head units without removing the filter head units from the dual-canister multi-filter system.

Although the present invention has been described in terms of particular embodiments, it is not intended that the invention be limited to these embodiments. Modifications within the spirit of the invention will be apparent to those skilled in the art. For example, multi-canister water-filtration systems may employ more than two canister-type water filters and more than a single pair of pressure gauges. Additional types of filter-monitors devices may be included in alternative examples of the multi-canister water-filtration system. The multi-canister water-filtration systems to which the current application is directed may have various different dimensions and use various different types of fasteners and fittings to securely mount the canister-type filters within the multi-canister water-filtration-system assembly to provide separate input and output pipe branches to each canister-type water filter.

It is appreciated that the previous description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

1. A multi-canister water-filtration system comprising:
an input pipe that branches into two or more canister-input pipes;
a shelf-like metal housing that mounts two or more canister-type water filters and that includes at least two pressure gauges, the two or more canister-input pipes each connected to one of the two or more canister-type water filters; and
two or more canister-output pipes, each connected to one of the two or more canister-type water filters, that input filtered water to an a multi-canister-water-filtration-system output pipe.

2. The multi-canister water-filtration system of claim I wherein a first pressure-gauge tap in one of the two or more canister-input pipes connected to a monitored canister-type water filter directs pressurized water to a first pressure gauge of the at least two pressure gauges and a second pressure-gauge tap in one of the two or more canister-output pipes connected to the monitored canister-type water filter directs pressurized water to a second pressure gauge of the at least two pressure gauges.

3. The multi-canister water-filtration system of claim 2 where comparison of a reading displayed by the first pressure gauge and a reading displayed by the second pressure gauge indicates a pressure drop across the monitored canister-type water filter.

4. The multi-canister water-filtration system of claim 1 wherein the shelf-like metal housing includes apertures through which pressure-relief buttons of the two or more canister-type water filters extend.

5. The multi-canister water-filtration system of claim 1 wherein canister housings of the two or more canister-type water filters may be unscrewed from corresponding head units of the two or more canister-type water filters to allow filter media within the two or more canister-type water filters to replaced without disassembly of the head units of the two or more canister-type water filters from the shelf-like metal housing.

6. The multi-canister water-filtration system of claim 1 including two canister-type water filters.
